(19) United States
(12) Patent Application Publication
(10) Pub. No.: US 2010/0237081 A1
(43) Pub. Date: Sep. 23, 2010

(54) INNER SHELL FOR A PRESSURE VESSEL

(75) Inventor: Markus Lindner, Mainz (DE)

Correspondence Address: FRASER CLEMENS MARTIN & MILLER LLC, 28366 KENSINGTON LANE, PERRYSBURG, OH, 43551-4163, US

(73) Assignee: GM GLOBAL TECHNOLOGY OPERATIONS, INC., Detroit, MI (US)

(21) Appl. No.: 12/791,057

(22) Filed: Jun. 1, 2010

Related U.S. Application Data
(62) Division of application No. 11/956,863, filed on Dec. 14, 2007.

(51) Int. Cl. F17C 1/06

(52) U.S. Cl. 220/589; 220/560.06

(57) ABSTRACT

Disclosed is a vessel including an outer shell and an inner shell, the inner shell having spaced apart concave recesses formed therein to facilitate a thermal expansion and contraction of the inner shell to militate against failure thereof.

### CROSS-REFERENCE TO RELATED APPLICATION

This application is a divisional application of U.S. patent application Ser. No. 11/956,863, filed Dec. 14, 2007, hereby incorporated herein by reference in its entirety.

### FIELD OF THE INVENTION

The invention relates to a hollow vessel, and more particularly to a hollow pressure vessel having an outer shell and an inner shell fixed to a boss, the inner shell having an increased surface area over inner shells of pressure vessels known in the art to facilitate an expansion and a contraction thereof and to militate against failure of the inner shell.

### BACKGROUND OF THE INVENTION

Fuel cells have been proposed as a power source for electric vehicles and other applications. In proton exchange membrane (PEM) type fuel cells, hydrogen is supplied as a fuel to an anode of the fuel cell and oxygen is supplied as an oxidant to a cathode of the fuel cell. A plurality of fuel cells is stacked together in fuel cell stacks to form a fuel cell system. The fuel is typically stored in large, hollow pressure vessels, such as fuel tanks, disposed on an undercarriage of the vehicle.

The pressure vessels are typically multi-layered and include at least an inner shell and an outer shell. Inner shells may be manufactured using a variety of known methods including: injection molding; extrusion blow molding; blow molding; rotational molding; and the like. The inner shell is formed utilizing the rotational molding method by disposing a plurality of bosses in a die cavity with a polymer resin, heating the mold while it is rotated causing the resin to melt and coat walls of the die cavity, cooling the die, and removing the molded inner shell. The finished inner shell is fixed to the bosses at both ends. To form the outer shell, the molded inner shell may undergo a filament winding process. After the filament winding process, the outer shell may substantially abut the inner shell and exert a compressive force on the inner shell.

At normal conditions such as ambient temperature and pressure, the inner shell and the outer shell each have an original shape, and no stresses are imparted on the inner shell. Variations in the pressure and the temperature of the inner shell and the outer shell of the pressure vessel will influence the shapes thereof.

The outer shell typically bears a substantial portion of the load of the pressure vessel caused by fluid pressure. The outer shell will expand due to an increase in pressure. Simultaneously, the inner shell will expand and contact the outer shell without carrying the load caused by the pressure. An expansion of the outer shell at relatively low pressures, such as 0.5 MPa and above, will impart tension stresses in the inner shell caused by the pulling away of the inner shell from the bosses. An expansion of the outer shell at relatively high pressures, such as 70 MPa, will impart even greater tension stresses in the inner shell caused by an inner shell expansion and a pulling away from the bosses.

Due to a difference in the thermal expansion coefficient of the inner shell and the outer shell, an increase in temperature of the pressure vessel will cause the inner shell to expand toward the outer shell while the outer shell maintains the original shape, thereby imparting compression forces on the inner shell by the outer shell. A significant expansion of the inner shell has been observed at temperatures above about 80° C. A decrease in temperature of the pressure vessel will cause the inner shell to contract away from the outer shell while the outer shell maintains the original shape, thereby imparting tension forces on the inner shell as the inner shell pulls away from the bosses. A significant contraction of the inner shell has been observed at temperatures below about −80° C.

Repeated expansion and contraction of the material, as well as high compressive and tension forces, may result in cracking and mechanical failure of the inner shell, thereby minimizing a useful life of the vessel. Increased tension forces contribute more to the cracking and failure of a pressure vessel than do compressive forces. Accordingly, there is a need for an improved pressure vessel, and more particularly, a pressure vessel including an inner shell adapted to minimize the affect of tension forces imparted thereto.

It would be desirable to develop a hollow pressure vessel having an outer shell and an inner shell fixed to a boss, the inner shell adapted to minimize the affect of tension forces imparted thereto.

### SUMMARY OF THE INVENTION

Concordant and congruous with the present invention, a hollow pressure vessel having an outer shell and an inner shell fixed to a boss, the inner shell adapted to minimize the affect of tension forces imparted thereto, has surprising been discovered.

In one embodiment, a vessel comprises a hollow inner shell adapted to store a fluid, said inner shell having a plurality of concave recesses formed in an outer wall thereof; and an outer shell formed around said inner shell and forming a plurality of cavities between said inner shell and said outer shell adjacent the concave recesses.

In another embodiment, a vessel comprises a hollow inner shell adapted to store a fluid, said inner shell having a plurality of concave recesses formed in an outer wall thereof; an outer shell formed around said inner shell and forming a plurality of cavities between said inner shell and said outer shell adjacent the concave recesses; and a first boss adhered to said inner shell and forming a substantially fluid tight seal therebetween.

In another embodiment, a vessel comprises a blow molded hollow inner shell adapted to store a fluid, said inner shell having a plurality of concave recesses formed in an outer wall thereof; an outer shell formed around said inner shell and forming a plurality of cavities between said inner shell and said outer shell adjacent the concave recesses; a first boss adhered to said inner shell and forming a substantially fluid tight seal therebetween; and a second boss adhered to said inner shell and forming a substantially fluid tight seal therebetween.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a top plan view of an inner shell of a pressure vessel according to an embodiment of the invention;

FIG. 2 is a cross-sectional view of the inner shell vessel shown in FIG. 1 taken along line 2-2 and surrounded by an outer shell;

FIG. 3 is a fragmentary cross-sectional view of the pressure vessel of FIG. 2 with the pressure vessel at normal pressure and temperature conditions;

FIG. 4 is a fragmentary cross-sectional view of the pressure vessel of FIG. 2 with the pressure vessel at a temperature above normal conditions and at normal pressure conditions;

FIG. 5 is a fragmentary cross-sectional view of the pressure vessel of FIG. 2 with the pressure vessel at a temperature below normal conditions and at normal pressure conditions;

FIG. 6 is a fragmentary cross-sectional view of the pressure vessel of FIG. 2 with the pressure vessel at a temperature above normal conditions and at increased pressure conditions;

FIG. 7 is a fragmentary cross-sectional view of the pressure vessel of FIG. 2 with the pressure vessel at a temperature below normal conditions and at increased pressure conditions;

FIG. 8 is a top plan view of an inner shell of a pressure vessel according to an embodiment of the invention; and

FIG. 9 is a cross-sectional view of the inner shell vessel shown in FIG. 8 taken along line 8-8 and surrounded by an outer shell.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

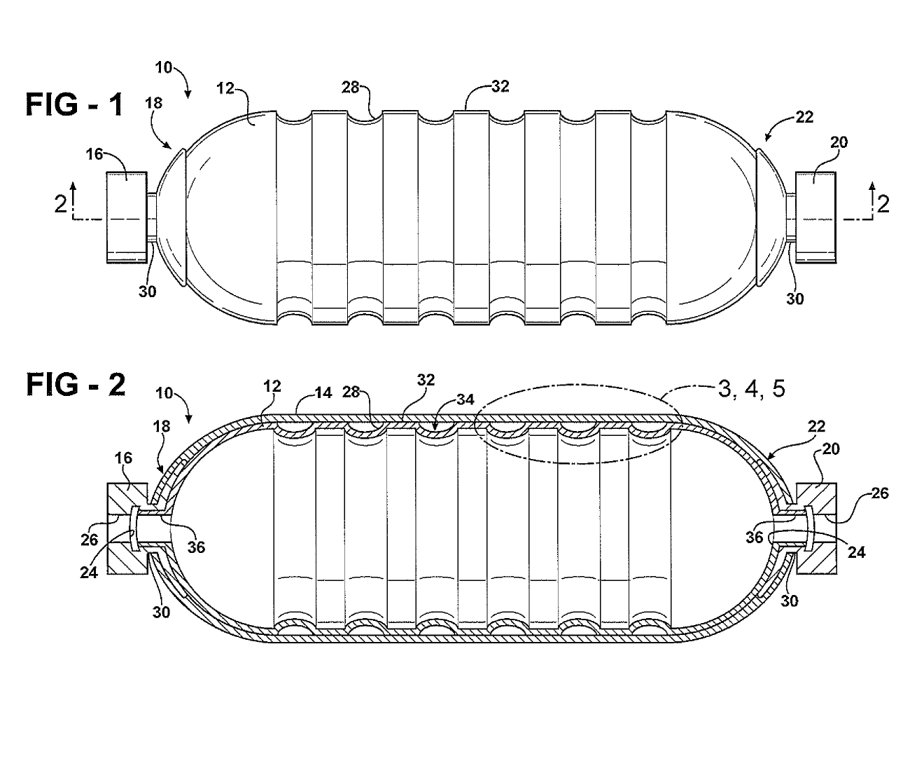

FIGS. 1 and 2 illustrate a hollow pressure vessel 10 having an inner shell 12 and an outer shell 14. The vessel 10 has a substantially cylindrical shape and is adapted to hold a pressurized fluid (not shown). It is understood that the vessel 10 may have any shape as desired. The pressurized fluid may be any fluid such as a gas, a liquid, and both a liquid and a gas, for example.

The vessel 10 includes a first boss 16 disposed in a first end 18 thereof and a second boss 20 disposed in a second end 22 thereof. The first boss 16 and the second boss 20 are a separately produced finish that each forms an opening into an interior of the vessel 10. The first boss 16 and the second boss 20 are typically shaped to accommodate a specific closure. The vessel 10 may include a single boss or any number of bosses, as desired. The bosses 16, 20 each include an annular groove 24 formed on an inner surface 26 thereof. The groove 24 is adapted to receive a portion of a hose, nozzle, conduit, or other means for fluid communication (not shown) with the bosses 16, 20 and the interior of the vessel 10. Rather than the groove 24, the inner surface 26 of the bosses 16, 20 may be threaded to receive the various means for fluid communication. It is also understood that the first boss 16 and the second boss 20 may be formed from any conventional material such as a plastic, steel, a steel alloy, or aluminum, for example. The bosses 16, 20 may also be blind bosses adapted to anchor the vessel 10 to another structure or pressure relief devices, as desired.

The inner shell 12 of the vessel 10 is a hollow container adapted to store the pressurized fluid. As shown, the inner shell 12 includes a plurality of spaced apart indentations 28 that define a plurality of lands 32 therebetween. In the embodiment shown in FIGS. 1 and 2, the indentations 28 are spaced apart annular channels formed in an outer wall of the inner shell 12 having a generally concave cross-sectional shape. Any number of indentations 28 may be formed in the inner shell 12 and the indentations 28 may have any cross-sectional shape such as rectangular and triangular, for example, as desired. By forming the indentations 28 in the outer wall of the inner shell 12, a surface area of the inner shell 12 is increased over the surface area of inner shells for pressure vessels as known in the art.

A first end of the inner shell 12 is received in an aperture formed by the inner surface 26 of the first boss 16 at the first end 18 of the vessel 10. A second end of the inner shell 12 is received in an aperture formed by the inner surface 26 of the second boss 20. The inner shell 12 may also be received on an outer surface 30 of the bosses 16, 20, as desired. As shown, the inner shell 12 is formed from a plastic such as polyethylene, PET, ethylene vinyl alcohol, or an ethylene vinyl acetate terpolymer, for example. The inner shell 12 may be formed from any moldable material such as aluminum, steel, a metal alloy, a glass, and the like, as desired.

The outer shell 14 of the vessel 10 is disposed on the inner shell 12. As shown, the outer shell 14 substantially abuts the lands 32 of the inner shell 12, thereby defining a plurality of cavities 34 between the indentations 28 of the inner shell 12 and the outer shell 14. The outer shell 14 is joined to the first boss 16 at the first end 18 and the second boss 20 at the second end 22 of the vessel 10. The outer shell 14 may be formed from any moldable material such as a metal and a plastic, for example. The outer shell 14 may be formed using a filament winding process. If the outer shell 14 is formed using the filament winding process, the outer shell 14 may be formed from a carbon fiber, a glass fiber, a composite fiber, and a fiber having a resin coating, as desired. It is understood that the material used to form the outer shell 14 may be selected based on the process used to affix the outer shell 14 to the inner shell 12, the use of the vessel 10, and the properties of the fluid to be stored in the vessel 10.

To form the vessel 10, the inner shell 12 is typically formed using a blow molding process. The first boss 16 and the second boss 20 are disposed in an open die (not shown) and the die is then closed. The first boss 16 and the second boss 20 may be heated prior to being disposed in the die to facilitate adhesion to the inner shell 12 as it is formed. Melted pellets or flakes of plastic are then extruded into a cavity formed by the die in the form of a parison (not shown). Because the parison is continuously extruded into the die, the parison is hollow. A fluid (not shown) is then caused to flow through the parison in the die causing the parison to expand and contact the walls of the die, thereby taking the shape of the cavity formed by the die. It is understood that the fluid may be any conventional fluid such as air, nitrogen, hydrogen, and oxygen, as desired. As the parison is caused to expand by the fluid, a portion of the parison is caused to contact, adhere to, and form a substantially fluid tight seal with the first boss 16. Another portion of the parison is caused to contact, adhere to, and form a substantially fluid tight seal with the second boss 20. It is understood that the inner shell 12 may be formed in a single process using any conventional process such as rotational molding, injection molding, extrusion blow molding, and the like, for example. Also, portions of the inner shell 12 may be formed in separate processes and subsequently welded or otherwise connected together.

As shown in FIG. 2, a neck portion 36 of the material forming the parison is blow molded into contact with the inner surfaces 26 of the bosses 16, 20. Material may be blown into the groove 24 and further into the inner surface 26. The material may be cut away or otherwise machined and removed from the bosses 16, 20, as desired. It is understood that the surfaces of the first boss 16 that contact the moldable material during the blow molding process may be etched, coated with a primer, or coated with an adhesive prior to the blow molding process to facilitate adhesion of the bosses 16, 20 to the moldable material. It is also understood that the bosses 16, 20 may include grooves, cavities, channels, or protuberances adapted to receive a portion of the material to mechanically attach the material thereto. Once the blow molded material has cooled sufficiently, the die is opened and the inner shell 12 is removed.

Carbon fibers impregnated with a resin are typically filament wound around the inner shell 12 to form the outer shell 14. The cooperation of the indentations 28 and the outer shell 14 to form the cavities 34 results in the inner shell 12 having an increased surface area relative to the surface areas of inner shells of vessels known in the art having the same volume and general shape. The resin impregnated carbon fibers of the outer shell 14 are applied to form a substantially fluid tight seal with the inner shell 12. To militate against the penetration of the resin and carbon fibers into the indentations 28, a protective layer (not shown) may be placed over the inner shell 12. The protective layer may be a foil, a plastic, a cloth, or another material, as desired. It is understood that the outer shell 14 may be applied by a dipping process in a molten polymer or metal, by spraying a coating, or by sewing a leather or fabric material onto the inner shell 12. Once the outer shell 14 is applied, the vessel 10 may be placed in an autoclave (not shown) to allow the resin of the outer shell 14 to cure. Once the resin of the outer shell 14 is cured, the vessel 10 is ready for use.

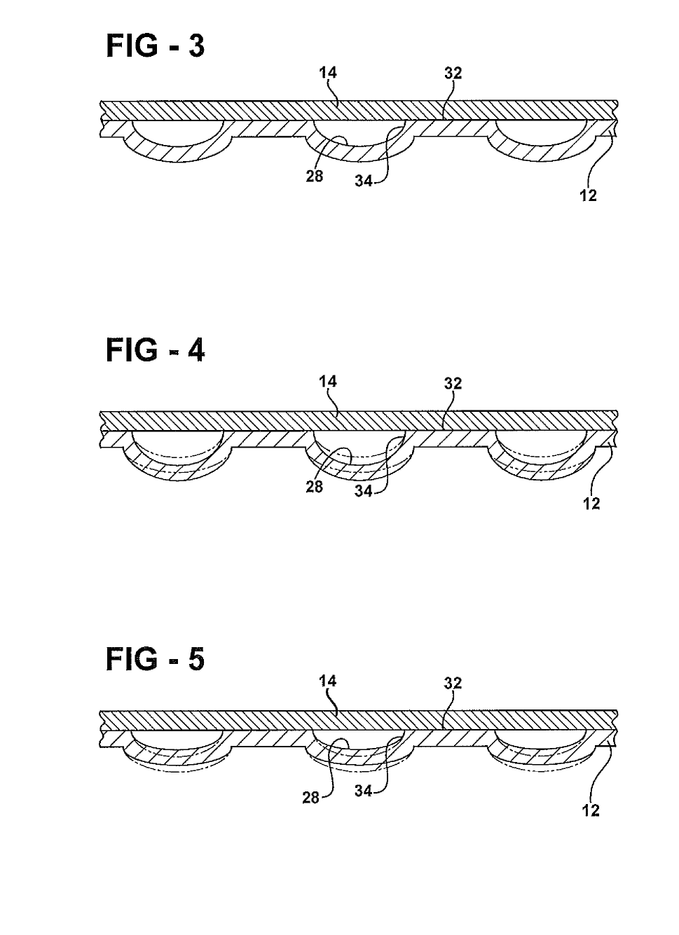

As shown in FIG. 3, the vessel 10 is at a normal pressure, typically between 80 and 120 kPA, and at a normal temperature, typically between −20° C. and 20° C., the portions of the material that form the indentations 28 maintain an original shape. At an elevated temperature as compared to the normal temperature and at normal pressure conditions, and because of a thermal expansion coefficient of the material used to form the inner shell 12, energy is transferred to the material forming the inner shell 12, thereby causing the inner shell 12 to expand. As the pressure within the vessel 10 increases, the inner shell 12 is caused to further expand toward the outer shell 14 of the vessel 10. Accordingly, as the inner shell 12 expands, the outer shell 14 maintains an original shape and size, thereby increasing the compressive force on the inner shell 14 by the outer shell 14 as compared to the compressive force during normal storage conditions of the vessel 10.

At a decreased temperature as compared to the normal temperature and at the normal pressure conditions, and because of a thermal expansion coefficient of the material used to form the inner shell 12, the material forming the inner shell 12 is caused to contract. Because the thermal expansion coefficient of the inner shell 12 is different than a thermal expansion coefficient of the outer shell, 14 and since the inner shell 12 is fixed at both ends to the bosses 16, 20, as the inner shell 12 contracts and pulls away from the bosses 16, 20, the inner shell 12 is subjected to increased tension forces. As shown in FIG. 5, as the inner shell 12 contracts, portions of the material that form the indentations 28 are caused to contract and deflect radially outwardly toward the outer shell 14, thereby minimizing the tension forces on the inner shell 12. Deflection of the portions of the material that form the indentations 28 towards the outer shell 14 minimizes the tension forces exerted on the inner shell 12 by causing the portions of the material that form the indentations 28 to deflect from a curvilinear cross-sectional shape to a substantially linear cross-sectional shape. Deflection of the portions of the material that form the indentations 28 minimizes the tension forces on the inner shell 12, thereby militating against a mechanical failure of the inner shell 12 such as by cracking and puncturing. By militating against a mechanical failure of the inner shell 12 of the vessel 10, a useful life of the vessel 10 is maximized.

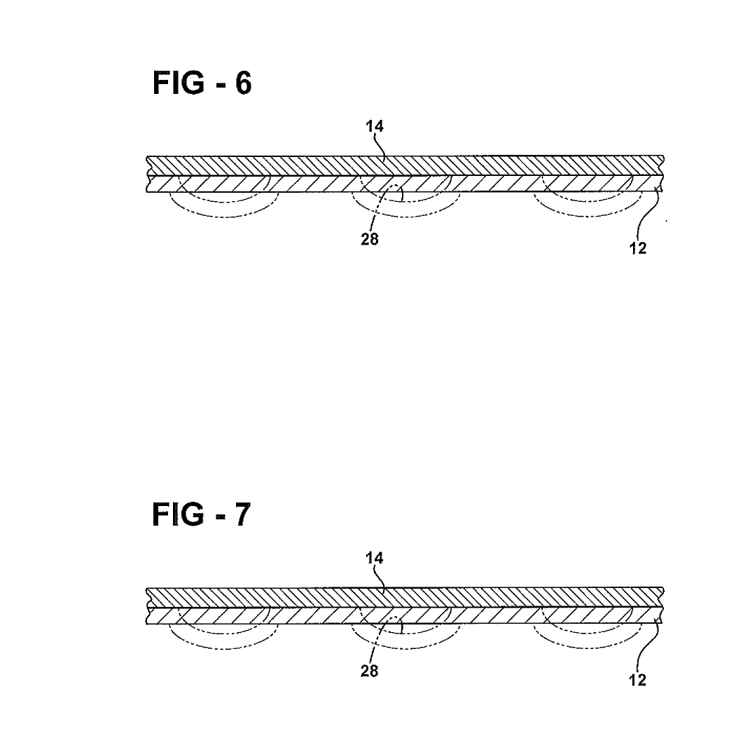

At a temperature above normal conditions and at a pressure above normal conditions, such as 0.5 MPa and above, and because of a thermal expansion coefficient of the material used to form the inner shell 12, energy is transferred to the material forming the inner shell 12, thereby causing the inner shell 12 to expand. As the pressure within the vessel 10 increases, the inner shell 12 is caused to expand toward the outer shell 14 of the vessel 10. Accordingly, as the inner shell 12 expands, the outer shell 14 may maintain an original shape and size, thereby increasing the compressive force on the inner shell 14 by the outer shell 14 as compared to the compressive force during normal storage conditions of the vessel 10. When a pressurized fluid is disposed within the vessel 10 and the pressure within the vessel 10 is above the normal pressure, the pressure on the inner shell 12 deflects the indentations 28 radially outward toward the outer shell 14, as shown in FIG. 6. Without the internal pressure on the material that forms the indentations 28 by the pressurized fluid the indentations 28 would deflect radially inwardly. By militating against a radially inward deflection of the material that forms the indentations 28, tension forces within the inner shell 12 are minimized. By minimizing the tension forces on the inner shell 12, and because tension forces contribute more to a failure of the inner shell 12 than compressive forces, failure of the inner shell 12 such as by cracking and puncturing is militated against.

At a temperature below normal conditions and at a pressure above normal conditions, such as 0.5 MPa and above, the pressure on the inner shell 12 causes an expansion thereof and deflects the material that forms the indentations 28 radially outward toward the outer shell 14, as shown in FIG. 7. Without the internal pressure on the material that forms the indentations 28 by the pressurized fluid the indentations 28 would deflect radially inwardly. By militating against contraction of the inner shell 12 and a radially inward deflection of the indentations 28, tension forces within the inner shell 12 are minimized. By minimizing the tension forces on the inner shell 12, and because tension forces contribute more to a failure of the inner shell 12 than compressive forces, failure of the inner shell 12 such as by cracking and puncturing is militated against.

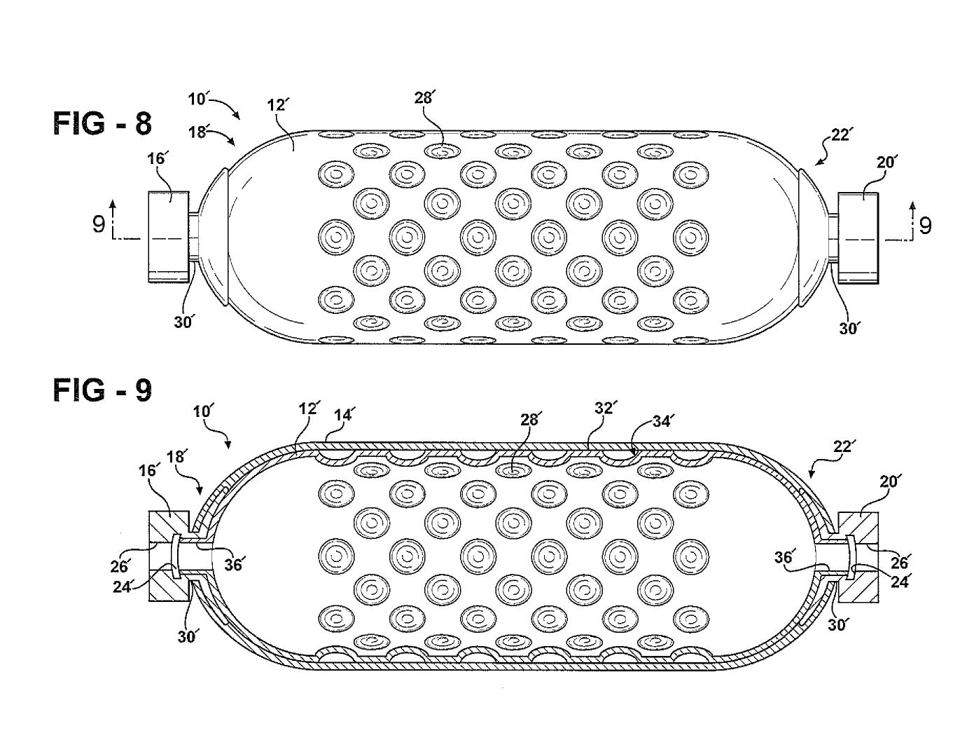

FIGS. 8 and 9 show a hollow pressure vessel 10′ according to another embodiment of the invention. The embodiment of FIGS. 8 and 9 is similar to the vessel 10 of FIG. 1, except as described below. Similar to the structure of FIG. 1, FIGS. 8 and 9 includes the same reference numerals accompanied by a prime (′) to denote similar structure.

The inner shell 12′ of the vessel 10′ is a hollow container adapted to store the pressurized fluid. As shown, the inner shell 12′ includes a plurality of spaced apart indentations 28′ that define a plurality of lands 32′ therebetween. In the embodiment shown in FIGS. 8 and 9, the indentations 28″ are spaced apart concave recesses formed in an outer wall of the inner shell 12′ and having a circular shape and a generally concave cross-sectional shape. Any number of indentations 28′ may be formed in the inner shell 12′ and the indentations 28′ may have any cross-sectional shape such as rectangular and triangular, for example, as desired. By forming the indentations 28′ in the outer wall of the inner shell 12′, a surface area of the inner shell 12′ is increased over the surface area of inner shells for pressure vessels as known in the art.

A first end of the inner shell 12′ is received in an aperture formed by the inner surface 26″ of the first boss 16′ at a first end 18′ of the vessel 10′. A second end of the inner shell 12′ is received in an aperture formed by the inner surface 26′ of the second boss 20′ at the second end 22″ of the vessel 10′. The inner shell 12′ may also be received on an outer surface 30″ of the bosses 16′, 20′, as desired. As shown, the inner shell 12′ is formed from a plastic such as polyethylene, PET, ethylene vinyl alcohol, or an ethylene vinyl acetate terpolymer, for example. The inner shell 12′ may be formed from any moldable material such as a metal, a glass, and the like, as desired.

At a temperature above normal conditions and at a pressure above normal conditions, such as 0.5 MPa and above, and because of a thermal expansion coefficient of the material used to form the inner shell 12′, energy is transferred to the material forming the inner shell 12′, thereby causing the inner shell 12′ to expand. As the material that forms the inner shell 12′ expands and the pressure within the vessel 10′ increases, the inner shell 12′ is caused to expand toward the outer shell 14′ of the vessel 10′. Accordingly, as the inner shell 12′ expands, the outer shell 14′ may maintain an original shape and size, thereby increasing the compressive force on the inner shell 14′ by the outer shell 14′ as compared to the compressive force during normal storage conditions of the vessel 10′. When a pressurized fluid is disposed within the vessel 10′ and the pressure within the vessel 10′ is above the normal pressure, the pressure on the inner shell 12′ deflects the indentations radially outward toward the outer shell 14′, as shown in FIG. 6. By militating against a radially inward deflection of the material that forms the indentations 28′, tension forces within the inner shell 12′ are minimized. By minimizing the tension forces on the inner shell 12′, and because tension forces contribute more to a failure of the inner shell 12′ than compressive forces, failure of the inner shell 12′ such as by cracking and puncturing is militated against.

At a temperature below normal conditions and at a pressure above normal conditions, such as 0.5 MPa and above, the pressure on the inner shell 12′ causes an expansion thereof and deflects the material that forms the indentations 28′ radially outward toward the outer shell 14′. By militating against contraction of the inner shell 12′ and a radially inward deflection of the indentations 28′, tension forces within the inner shell 12′ are minimized. By minimizing the tension forces on the inner shell 12′, and because tension forces contribute more to a failure of the inner shell 12′ than compressive forces, failure of the inner shell 12′ such as by cracking and puncturing is militated against.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A vessel comprising:
a hollow inner shell adapted to store a fluid, said inner shell having a plurality of concave recesses formed in an outer wall thereof; and
an outer shell formed around said inner shell and forming a plurality of cavities between said inner shell and said outer shell adjacent the concave recesses.

2. The vessel of claim 1, further comprising a first boss adhered to said inner shell and forming a substantially fluid tight seal therebetween.

3. The vessel of claim 2, further comprising a second boss adhered to said inner shell and forming a substantially fluid tight seal therebetween.

4. The vessel of claim 2, wherein a portion of a material forming said inner shell is disposed adjacent an inner surface of said first boss.

5. The vessel of claim 2, wherein said first boss is one of etched, coated with a primer, and coated with an adhesive to facilitate adhesion of said first said boss to said inner shell.

6. The vessel of claim 2, wherein said first boss includes one of a plurality of grooves, a plurality of cavities, a plurality of channels, and a plurality of protuberances formed on an inner surface thereof to facilitate mechanical attachment of said first said boss to said inner shell.

7. The vessel of claim 1, wherein said outer shell is formed by a filament winding process.

8. The vessel of claim 1, wherein said inner shell is formed by one of a rotational molding process and a blow molding process.

9. The vessel of claim 1, wherein said inner shell is formed from one of a polymer, aluminum, and steel.

10. The vessel of claim 1, wherein the concave recesses are adapted to deflect in response to thermal energy transferred to and from said inner vessel.

11. A vessel comprising:
a hollow inner shell adapted to store a fluid, said inner shell having a plurality of concave recesses formed in an outer wall thereof;
an outer shell formed around said inner shell and forming a plurality of cavities between said inner shell and said outer shell adjacent the concave recesses; and
a first boss adhered to said inner shell and forming a substantially fluid tight seal therebetween.

12. The vessel of claim 11, further comprising a second boss adhered to said inner shell and forming a substantially fluid tight seal therebetween.

13. The vessel of claim 11, wherein a portion of a material forming said inner shell is disposed adjacent an inner surface of said first boss.

14. The vessel of claim 11, wherein said first boss is one of etched, coated with a primer, and coated with an adhesive to facilitate adhesion of said first said boss to said inner shell.

15. The vessel of claim 11, wherein said first boss includes one of a plurality of grooves, a plurality of cavities, a plurality of channels channels, and a plurality of protuberances formed on an inner surface thereof to facilitate mechanical attachment of said first said boss to said inner shell.

16. The vessel of claim 11, wherein said outer shell is formed by a filament winding process.

17. The vessel of claim 11, wherein said inner shell is formed by one of a rotational molding process and a blow molding process.

18. The vessel of claim 11, wherein said inner shell is formed from a polymer.

19. The vessel of claim 11, wherein the concave recesses are adapted to deflect in response to thermal energy transferred to and from said inner vessel.

20. A vessel comprising:
a blow molded hollow inner shell adapted to store a fluid, said inner shell having a plurality of concave recesses formed in an outer wall thereof;
an outer shell formed around said inner shell and forming a plurality of cavities between said inner shell and said outer shell adjacent the concave recesses;
a first boss adhered to said inner shell and forming a substantially fluid tight seal therebetween; and
a second boss adhered to said inner shell and forming a substantially fluid tight seal therebetween.
